(19) United States
(12) Patent Application Publication
(10) Pub. No.: US 2019/0066304 A1
(43) Pub. Date: Feb. 28, 2019

(54) REAL-TIME OBJECT SEGMENTATION IN LIVE CAMERA MODE

(71) Applicant: Microsoft Technology Licensing, LLC, Redmond, WA (US)

(72) Inventors: Ryuichi HIRANO, Renton, WA (US); Li HUANG, Sammamish, WA (US); Eun Ji LEE, Auburn, WA (US); Mark-Gil Bongato PARAYNO, Seattle, WA (US); Linjun YANG, Sammamish, WA (US); Meenaz Aliraza MERCHANT, Kirkland, WA (US)

(73) Assignee: Microsoft Technology Licensing, LLC, Redmond, WA (US)

(21) Appl. No.: 15/693,388

(22) Filed: Aug. 31, 2017

(51) Int. Cl. G06T 7/12; H04N 5/232; G06K 9/62; G06K 9/00

(52) U.S. Cl. CPC G06T 7/12; H04N 5/23293; G06K 9/627; G06F 3/04817; G06T 2207/20081; G06T 2207/20008; G06K 9/00624

(57) ABSTRACT

Systems and methods related to segmenting objects detected in an input view via a camera application in a live camera mode of an electronic device are disclosed herein. In some example aspects, a real-time object segmentation system is provided that receives input views during the live camera mode. The live camera mode may consist of at least one input view that is displayed on the screen of the electronic device prior to the capturing of a static image. The live camera mode may receive multiple views as the electronic device is moved, and these input views may be processed using at least one machine-learning algorithm to identify (or recognize) one or more objects. Based on the identification of the object or objects within the input view, at least one selectable action response may be provided to the user.

### BACKGROUND

Creating accurate machine learning models capable of isolating and identifying multiple objects in an image remains a challenge in the field of image analysis and recognition. Isolating and identifying multiple objects in a live camera mode (e.g., without capturing an image) is even more challenging. Current object recognition systems detect and classify objects in static images rather than in a live camera view. Once a photograph is captured, current object recognition systems may isolate portions of the image to detect various objects located within the static image. Current object recognition systems are applied to static images and do not utilize live detection technology to isolate or mask portions of a live camera view. Furthermore, current object detection systems use rectangular bounding boxes to crop portions of the static image to identify the object. However, using rectangular bounding boxes is inadequate for accurately capturing focused objects that are not rectangular in a view. Inconsistencies in masking and clipping objects from a static image using rectangular bounding boxes may lead to recognition errors and an unsatisfactory user experience.

It is with respect to these and other general considerations that example aspects, systems, and methods have been described. Also, although relatively specific problems have been discussed, it should be understood that the examples should not be limited to solving the specific problems identified in the background.

### SUMMARY

Implementations described and claimed herein address the foregoing problems by providing methods and systems for real-time freeform object segmentation. Rather than relying on a static image for processing, the methods and systems disclosed herein may recognize objects during a live camera mode. The live camera mode may be provided by an electronic device, e.g., by displaying a digital reproduction (e.g., in a viewing window) of a live scene as it is received by the electronic device through a camera lens. While in live camera mode, the methods and systems disclosed herein may use machine-learning algorithms and/or trained models to automatically segment and accurately identify objects observed during the live camera mode. The objects may be isolated through the creation of a freeform boundary identifier, which may also be referred to herein as “smart dots.” Smart dots may automatically form around an object within the live camera mode, and when the focus of the camera changes, the smart dots may dynamically move to form around another object in the view. In this way, by altering objects observed during the live camera mode and/or altering the focus on objects in the live camera mode, a user is able to control the object(s) being identified in the view by the system. As the electronic device in the live camera mode is moved to bring different objects into the view, the new objects are segmented and processed, whereby the methods and systems disclosed herein may identify and recognize the new objects.

In some example aspects, at least one boundary identifier may be displayed on the screen of an electronic device during a live camera mode. If the electronic device is moved such that one or more different objects come within the viewing window, the at least one boundary identifier may automatically outline any new objects in the viewing window. In other example aspects, the boundary identifier may be visible or invisible to the user. For example, the boundary identifier may be visible on the screen in the form of smart dots. Conversely, the boundary identifier may be invisible on the screen of the electronic device. When an object is isolated by the boundary identifier, the object may be masked or clipped from other parts of the view. For example, if the camera focuses on an object that is nearest to the electronic device, the background behind the object, as displayed on the screen of an electronic device, may be blurred or dimmed so that the object in focus may become more pronounced. On the other hand, if the camera focuses on an object that is further away than the nearest object, then the nearest object may be blurred or dimmed so that the background or distant objects may be more pronounced.

In yet other example aspects, after an object is identified and segmented within a live camera mode, the object may be processed and compared against trained models, which may include a database of objects and object identifiers. Machine learning algorithms may be applied to the segmented object. The segmented object may then be recognized and related information and/or selectable action responses may appear on the screen of the electronic device. For example, related information may refer to any facts, data, trends, etc., associated with the segmented object and may be generated (e.g., based on an Internet search) and presented (e.g., as an overlay) on the viewing window. Additionally or alternatively, selectable action responses may enable a user to respond or take action with respect to the segmented object, e.g., get directions to the nearest store offering the segmented object, launch a website for purchasing the segmented object, launch a search query to obtain related information, etc. For example, a segmented object may have been recognized as a certain type of shoe according to the machine learning algorithms and trained models. As a result, a selectable action response may be displayed in the viewing window that consists of a selectable “map” button for displaying directions to the nearest store currently offering the certain type of shoe for sale. Another selectable action response may include a link to the product page of the identified shoe on the Amazon® online store.

When the electronic device is moved and a new object comes into view during the live camera mode, the boundary identifier may form around the new object, the new object may be analyzed and recognized, and related information and/or selectable action responses may change accordingly. Similarly, when a focus of the view during the live camera mode changes from a first object to a second object (e.g., changing focus from an object in a foreground to an object in a background), the boundary identifier may form around the second object, the second object may be analyzed and recognized, and the related information and/or selectable action responses may change. For example, when the focus changes to the person holding the object, the boundary identifier may form around the person, who may be recognized, and the subsequent related information and/or selectable action responses may be associated with the person, rather than the object that the person is holding.

A processor-implemented method for segmenting objects in a live camera mode of an electronic device is disclosed herein. The processor-implemented method includes receiving at least one input view via a camera application in a viewing window on the electronic device. The at least one input view may be processed and at least one object within the at least one input view may be recognized. The method further includes providing at least one selectable action response associated with the at least one recognized object in the viewing window of the electronic device.

In another aspect, a computing device comprising at least one processing unit and at least one memory storing processor-executable instructions that when executed by the at least one processing unit cause the computing device to receive at least one input view via a camera application in a viewing window on the computing device, is provided. The at least one input view may be processed, and at least one object within the at least one input view may be recognized. At least one boundary identifier may be applied to the at least one object, and at least one selectable action response associated with the at least one recognized object may be provided in the viewing window of the computing device.

In yet another aspect, a processor-readable storage medium storing instructions for executing on one or more processors of a computing device, a method for segmenting objects in the viewing window of the computing device is provided. The method may receive at least one input view via a camera application in a viewing window on the electronic device and process the at least one input view. At least one object within the at least one input view may be recognized, and at least one boundary identifier may be applied to the at least one object. The method further includes providing at least one action response associated with the at least one recognized object in the viewing window of the computing device.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTIONS OF THE DRAWINGS

FIG. 1 illustrates an example of a distributed system for implementing a real-time object segmentation system.

FIG. 2 is a flow chart illustrating a method for segmenting objects in a live camera mode.

FIG. 3 is a block diagram illustrating a view processor.

FIG. 4A illustrates an example of an electronic device in live camera mode.

FIG. 4B illustrates an example of an electronic device in live camera mode providing visible boundary identifiers.

FIG. 4C illustrates an example of an electronic device in live camera mode with visible boundary identifiers and selectable action responses.

FIG. 5 is a block diagram illustrating example physical components of a computing device with which aspects of the disclosure may be practiced.

FIGS. 6A and 6B are simplified block diagrams of a mobile computing system in which aspects of the present disclosure may be practiced.

FIG. 7 is a simplified block diagram of a distributed computing system in which aspects of the present disclosure may be practiced.

FIG. 8 illustrates a tablet computing device for executing one or more aspects of the present disclosure.

### DETAILED DESCRIPTIONS

In the following detailed description, reference is made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or devices. Accordingly, example aspects may take the form of a hardware implementation, a software implementation, or an implementation combining software and hardware aspects. The following detailed description is therefore not to be taken in a limiting sense, and the scope of the present disclosure is defined by the appended claims and their equivalents.

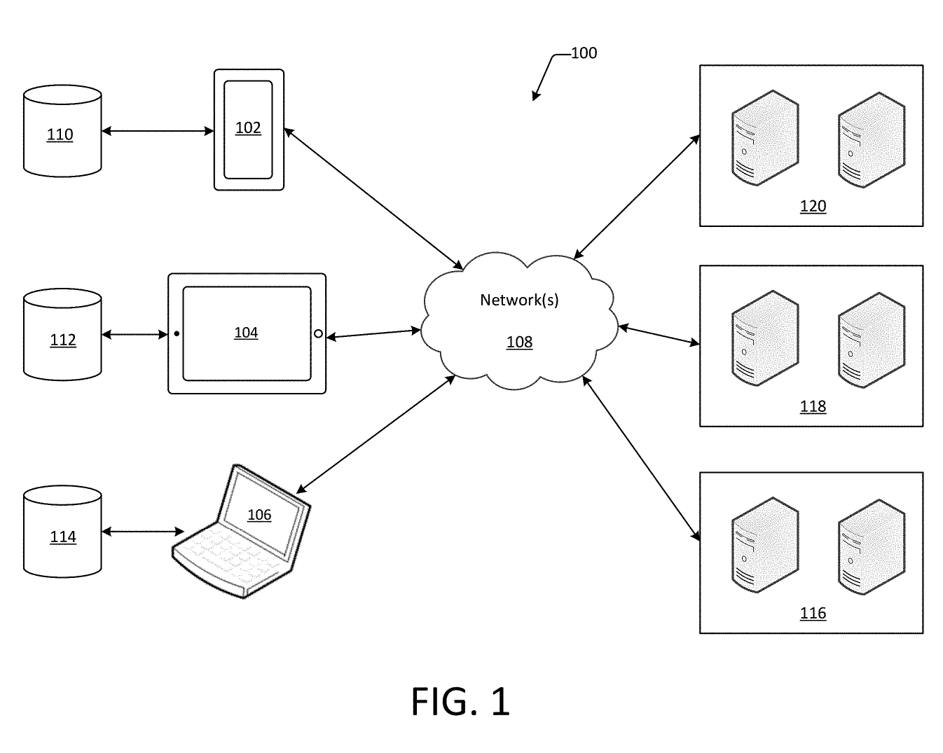

FIG. 1 illustrates an example of a distributed system for implementing a object segmentation and recognition system in a live camera mode.

A system implementing a real-time object segmentation system may be executed on electronic devices including but not limited to client devices such as mobile phone 102, tablet 104, and personal computer 106. The disclosed system may receive at least one and/or a series of views while running the camera application in a live camera mode (i.e., without capturing a static image). The disclosed system may then process the view or views locally, remotely, or using a combination of both. During processing, the disclosed system may rely on local and/or remote databases to generate an appropriate action response to provide back to the user. This may be accomplished by utilizing local data (e.g., local datasets 110, 112, 114) stored in a local database associated with client devices 102, 104, 106, and/or remote databases stored on or associated with servers 116, 118, 120, or a combination of both. The local and/or remote databases may access at least one machine-learning algorithm that may be applied to an input view during the live camera mode. The machine-learning algorithm(s) may compare the input view to at least one trained model with pre-identified objects. The comparison of the input view to the trained model may allow the system disclosed herein to accurately identify at least one object in a view during the live camera mode.

In some example aspects, the machine-learning algorithm(s) may use deep convolutional neural networks that compare the input view to one or more images, frames, cropped objects, etc., in the trained model(s). Each pixel of an input view may be analyzed and compared with pixels from frames and/or cropped objects in the trained model. In aspects, each pixel may be associated with a certain number that characterizes a level of darkness or lightness of the pixel. The neural network may then process the darkness/lightness numbers of each pixel into an array and compare that array with the already-stored objects that are part of a trained model. If the two arrays are similar, then the object may be identified accordingly. If the two arrays are dissimilar, then a further comparison with another frame from the trained model may be necessary to accurately identify the object from the input view.

In some example aspects, the application of the machine-learning algorithms, including but not limited to convolutional neural networks, may be executed locally on devices 102, 104, and 106. In other example aspects, the application of the machine-learning algorithms, including but not limited to convolutional neural networks, may be executed remotely on servers 116, 118, and/or 120 with comparison results communicated over the network 108. In yet other example aspects, the machine-learning algorithms, including but not limited to convolutional neural networks, may be executed on a combination of local processors (e.g., processors located on devices 102, 104, and 106) and remote processors (e.g., processors located on servers 116, 118, and 120).

Mobile phone 102 may utilize local dataset 110 and access servers 116, 118 and/or 120 via network(s) 108 to process the input view data, recognize the object or objects located within the input view, and provide at least one intelligent action response associated with the recognized object back to the user. In other example aspects, tablet 104 may utilize local database 112 and network(s) 108 to synchronize the relevant tokens and features extracted from the processed input view data, the subsequent segmented and recognized object(s) in the input view, and the intelligent action response(s) that are provided back to the user across one or more client devices and across one or more servers running the real-time object segmentation system. For example, if the initial input view data is received on tablet 104, the input view data and subsequent recognized object(s) and selectable action response(s) may be saved locally in database 112, but also shared with client devices 102, 106 and/or servers 116, 118, 120 via the network(s) 108.

In other example aspects, the real-time object segmentation system may be deployed locally. For instance, if the system servers 116, 118, and 120 are unavailable (e.g., due to network 108 being unavailable or otherwise), the real-time object segmentation system may still operate on a client device, such as mobile device 102, tablet 104, and/or computer 106. In this case, at least a subset of the trained dataset applicable to the client device type (e.g., mobile device, tablet, laptop, personal computer, etc.) and at least a client version of the machine-learning algorithms may be locally cached so as to automatically respond to relevant tokens (e.g., pixels) and features extracted from input view data on the client device. The system servers 116, 118 and/or 120 may be unavailable by user selection (e.g., intentional offline usage) or for a variety of other reasons, including but not limited to power outages, network failures, operating system failures, program failures, misconfigurations, hardware deterioration, and the like.

As should be appreciated, the various methods, devices, components, etc., described with respect to FIG. 1 are not intended to limit systems 100 to being performed by the particular components described. Accordingly, additional topology configurations may be used to practice the methods and systems herein and/or components described may be excluded without departing from the methods and systems disclosed herein.

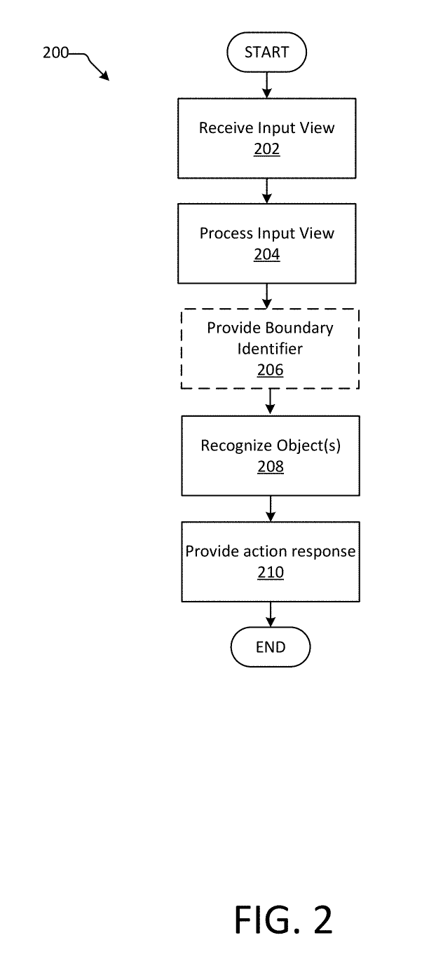

FIG. 2 is a flow chart illustrating a method for segmenting objects in real-time.

Method 200 may begin with receive input view operation 202. Method 200 may rely on camera hardware that can receive and process several input views in a live camera mode without capturing a static image. Each input view may be received through camera hardware and processed through a camera application executing on a computing device (e.g., a mobile phone, a tablet with a camera, etc.). The input views may be displayed on the screen of an electronic device, effectively serving as a live preview of a static image that may subsequently be captured. At least one input view may be received by the real-time object segmentation system at operation 202. In some example aspects, multiple input views may be received by the real-time object segmentation system at operation 202.

The input view received at operation 202 may be processed at operation 204. The process input view operation 204 may include, but is not limited to, applying at least one machine-learning algorithm to the input view. The at least one machine-learning algorithm may consist of a convolutional neural network that analyzes the input view at the pixel level. The pixels of the input view may be compared to a trained model that is part of the at least one machine-learning algorithm. The trained model may possess numerous static images of pre-identified objects. The machine-learning algorithm may proceed to automatically compare the pixels of the input view to the pixels of the pre-identified objects of the static images in the trained model. In some example aspects, the pixel comparison between the input view and the trained model may involve using an image encoder to extract features from the input view and converting the extracted features into one or more feature vectors. The one or more feature vectors may then be compared to a library of known images with known feature vectors. In aspects, features may include, among other things, a level of darkness or lightness, a level of opacity/translucency, a YRGB (or RGB) color array, chroma features, and the like. If one or more feature vectors of the input view are similar to one or more feature vectors of a known image in the library (or a pre-identified object in the library), then the input view may be classified accordingly. For example, if a feature vector of a segmented object in an input view matches a feature vector of a pre-identified object or image from the trained model that is classified as a “running shoe,” the segmented object may also be classified as a running shoe. In further example aspects, the trained model may be more specific by identifying manufacturer logos and a product type (e.g., the type and model of a running shoe).

During processing of the input view, objects located in the input view may be isolated by creating a freeform border around the edges of the object to mask and/or clip the object from the input view scene. Method 200 may rely on machine-learning algorithms and/or trained models to accurately segment objects from input views. For example, a convolutional neural network may be applied to an input view, in which pixels of an image may be compared with pixels of pre-identified images or objects of a trained model. The results of the comparison may prompt method 200 to isolate (or segment) certain identified objects from the input view. As a result of this object isolation/segmentation, provide boundary identifier operation 206 may be executed. In some example aspects, a visible boundary identifier may form around the identified object or objects within the input view. For example, the visible boundary identifier may be in the form of smart dots; or in other example aspects, the boundary identifier may be in the form of a solid line that traces around the edges of the object in the input view. In other example aspects, a visible boundary identifier may not be provided to the user. That is, although a boundary identifier may be applied in the background for processing the method 200, the boundary identifier may not always be visible to the user. For example, in a noisy input view with several objects, providing a visible boundary identifier for each object may overcrowd the input view. To avoid overcrowding, method 200 may automatically hide the boundary identifier from the user. As a result, in some example aspects, provide boundary identifier operation 206 may not be executed.

Following process input view operation 204 and optional provide boundary identifier operation 206, recognize object operation 208 may be executed. According to the data received from the process operation 204, the object or objects located within the input view may be accurately recognized. In some example aspects, the objects located within the input view(s) displayed in the live camera view may be visibly labeled. For example, a shoe that is recognized in the input view may have a label “shoe” displayed over or near it within the viewing window. In other example aspects, the machine-learning algorithm may be able to identify the specific type of shoe that is located within the input view. In such an instance, a Nike® Roshe One shoe observed in the live camera mode may be labeled “Nike Roshe One” within the viewing window (e.g., digital display screen) of the electronic device.

After objects within the input view are recognized at operation 208, provide action response operation 210 may be executed. In some example aspects, when objects located within the input view are specifically recognized (e.g., by type and model number such as a Nike® Roshe One shoe), a selectable action response may also be specific. For example, with reference to the example above, a selectable action response may redirect the user to a map application, displaying directions to the nearest store that sells the specific object identified in the input view (e.g., the nearest store that carries the Nike® Roshe One shoe in stock). In other example aspects, the selectable action response may be a clickable label that redirects to a search engine. For example, a user may be able to select the label “Nike® Roshe One,” which may redirect to a search engine with the query input “Nike® Roshe One.”

In further example aspects, the object located within the input view may be a person. According to the process input view operation 204 and the machine-learning algorithms that were applied to the input view, the person may be identified. In some aspects, the machine-learning algorithms may access personal photographs associated with the electronic device to identify or recognize the person. Similar action responses as discussed previously may be provided to the user. For example, the name of a celebrity may appear on the screen of the electronic device. The name may be a clickable button that activates a search engine with the name of the celebrity as the search engine query.

In other example aspects, more than one object may be located within the input view. For example, a shoe and a basketball may be located within the input view. Both the shoe and the basketball may be identified during process view operation 204, and boundaries (e.g., smart dots) may surround each of the objects at provide boundary identifier operation 206. After the shoe and the basketball are recognized at operation 208, the user may toggle back and forth among multiple objects displayed in the input view. For example, the user may be able to manually select the shoe and subsequently select the basketball. The action responses provided at operation 210 may also differ among the multiple objects. For example, when the user selects the shoe, the selectable action response may redirect the user to a search engine with the query input “Nike® Roshe One.” On the other hand, when the user selects the basketball, the selectable action response may redirect the user to a search engine with the query input “Wilson® Evolution Game indoor basketball.” To toggle back and forth among objects located within the input view on an electronic device with a touch screen, a user may tap the objects on the screen. Alternatively, on electronic devices with or without touch screens, a user may be able to toggle back and forth among objects by adjusting the focus of the camera. For example, the selected object may be located within the area of focus of the camera and closest to the center of the screen.

As should be appreciated, the various methods, devices, components, etc., described with respect to FIG. 2 are not intended to limit systems 200 to being performed by the particular components described. Accordingly, additional topology configurations may be used to practice the methods and systems herein and/or components described may be excluded without departing from the methods and systems disclosed herein.

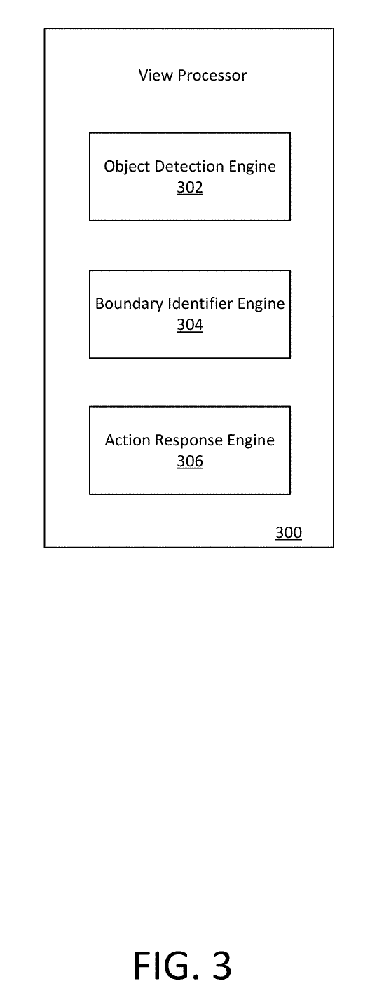

FIG. 3 is a block diagram illustrating a view processor.

View processor 300 may be configured to receive one or more input views from a camera application running in live camera mode (e.g., before a static image is captured by the camera). The input views that are received by view processor 300 may be sent to object detection engine 302. Object detection engine 302 may be configured to apply machine-learning algorithms equipped with trained models to the input views. The machine-learning algorithms may then be able to isolate (or segment) objects located within the input views. Object detection engine 302 may also be configured to communicate with databases storing the trained model of pre-identified objects. Before specifically identifying and labeling any objects in the input view, view processor 300 may first detect if an object exists by utilizing the object detection engine 302. Relying on the machine-learning algorithms, object detection engine 302 may compare the input views with the images and objects of the trained model and determine which objects are located within the input views.

Boundary identifier engine 304 may be configured to apply a boundary identifier on the objects that were detected by the object detection engine 302. As discussed previously, the boundary identifier may be a visible boundary (e.g., smart dots), or in some example aspects, the boundary identifier may be invisible to the user. As the electronic device is moved such that different objects are observed within the viewing window, the boundary identifier engine 304 may be configured to reapply the boundary identifier. In other examples, a user holding a mobile phone may be unable to hold the mobile phone steady, causing jitter in the input view. The boundary identifier engine 304 may be configured to account for such jitter and may continuously reapply the boundary identifier to the input view. In some example aspects, view processor 300 may be receiving several input view (e.g., as the electronic device is moved). The boundary identifier engine 304 may be configured to constantly reapply a boundary identifier to each of these views. From the user perspective, the boundary identifier may seem to constantly form around at least one detected object on the screen of the electronic device.

Action response engine 306 may be configured to provide one or more selectable action responses on the screen of the electronic device that are associated with one or more recognized objects. For example, each object identified within the input view in the live camera mode may be associated with a label identifying the object. The label may be generated by action response engine 306, and, in some example aspects, the label may be a clickable button that redirects to a search engine or similar action response. For example, an object that is identified as a Nike® Roshe One shoe may receive a label from action response engine 306 identifying the shoe as “Nike® Roshe One.” The “Nike® Roshe One” label may be a clickable button that redirects the user to the product page of an online store (e.g., Amazon® online marketplace, Nike® website, etc.). In other example aspects, the label (or another selectable link or icon) may redirect the user to a maps application with directions to the nearest store that currently offers the Nike® Roshe One shoes in stock. In further example aspects, the label may redirect to a search engine with “Nike® Roshe One” as the search query. Other selectable action responses may be available, including but not limited to, action responses that redirect to third-party applications, utilize public social media profiles, geolocation data, etc. In further example aspects, more than one selectable action response may be provided on the screen of the electronic device.

As should be appreciated, the various methods, devices, components, etc., described with respect to FIG. 3 are not intended to limit systems 300 to being performed by the particular components described. Accordingly, additional topology configurations may be used to practice from the methods and systems disclosed herein.

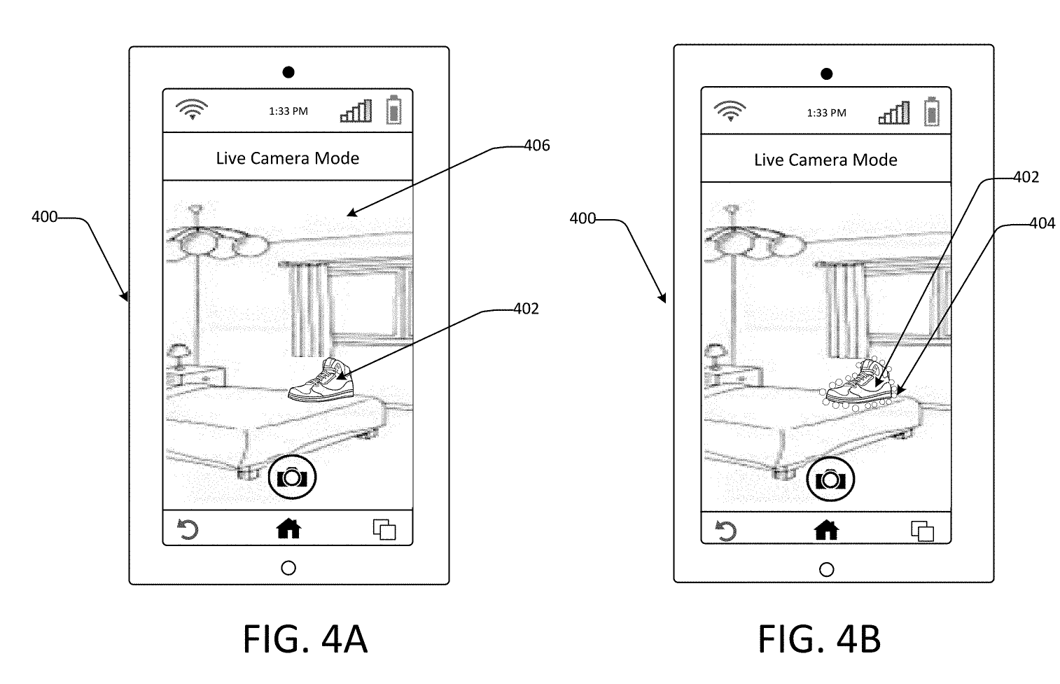

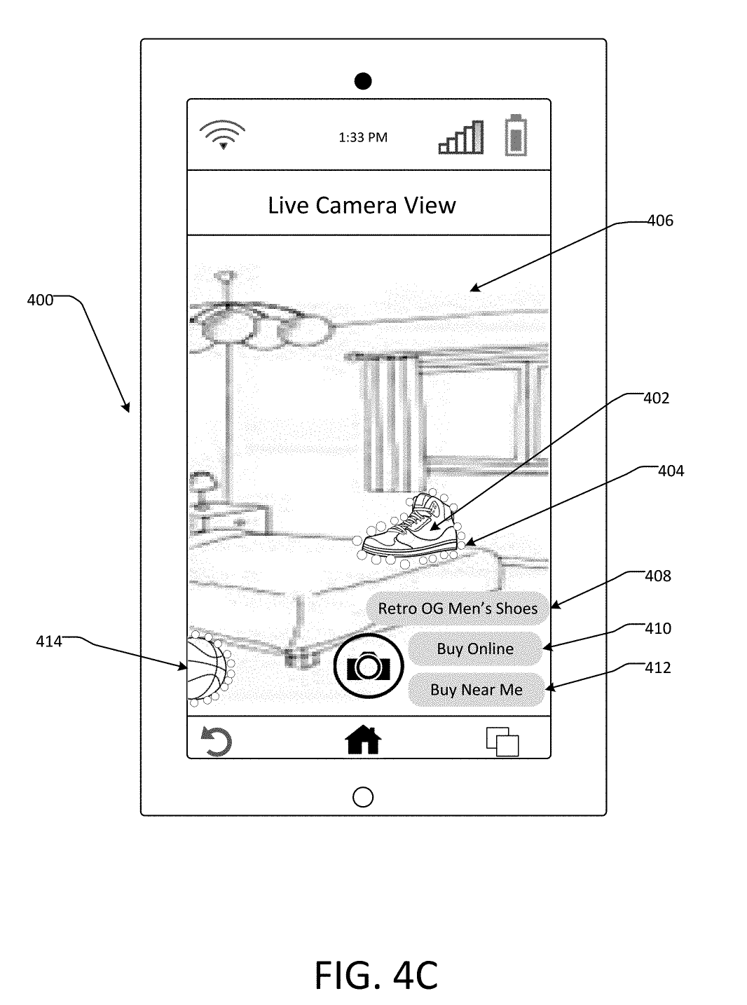

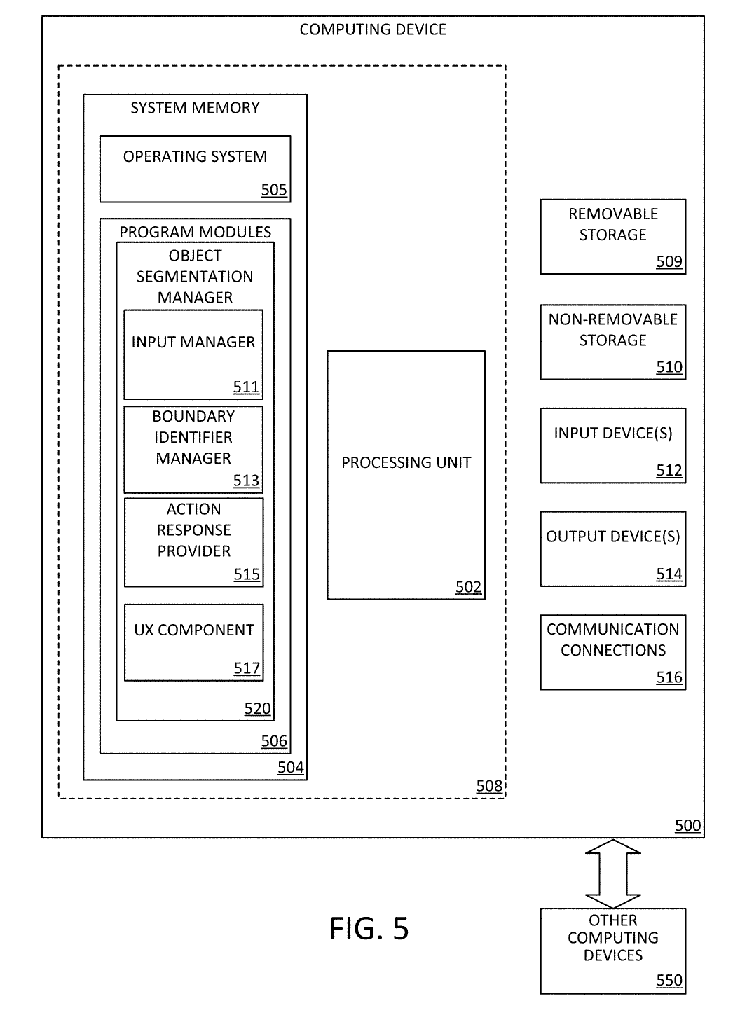

FIG. 4A illustrates an example of an electronic device in live camera mode.

As illustrated, electronic device 400 is running a camera application in live camera mode. Although an input view is presented within viewing window 406 of the electronic device, a static image (e.g., picture) has not been captured by the camera associated with the electronic device. In the live camera mode, shoe 402 is displayed. As a camera of the electronic device 400 is redirected to observe different objects within the viewing window 406, the input view continues to change and the pixels and pixel values continue to change. At any moment, the current input view may be processed by a view processor (described in FIG. 3), utilizing the methods described in FIG. 2. As previously described, the input views that are received by the view processor are used as input to machine-learning algorithms that compare the input views against trained models of images with pre-identified objects. The comparisons may result in detecting objects and isolating those objects from the input views.

FIG. 4B illustrates an example of an electronic device in live camera mode with visible boundary identifiers.

As illustrated, shoe 402 has now been detected by the methods and systems disclosed herein. A boundary identifier 404 has been applied to shoe 402, isolating (or segmenting) shoe 402 from the rest of the input view. In aspects, the segmented object (e.g., shoe 402) is identified by visible boundary identifier 404. The boundary identifier 404 may be visible to the user in the form of smart dots, as depicted. In other example aspects, the boundary identifier 404 may be a solid line outlining the edges of the object (e.g., shoe 402) in the input view. In some example aspects, the boundary identifier 404 may not be precisely touching the edges of the object in the input view. The boundary identifier may be intentionally larger than the object detected in the input view in order to account for the constant movement of the electronic device (e.g., jitter). As described previously, jitter may cause fluctuations in the input view, and the real-time object segmentation system disclosed herein may be configured to account for these movement errors.

FIG. 4C illustrates an example of an electronic device in live camera mode with visible boundary identifiers and selectable action responses.

As illustrated, shoe 402 has been detected by the real-time object segmentation system disclosed herein. A boundary identifier 404 has been applied to shoe 402. Additionally, action response labels 408, 410, and 412 have been presented on the viewing window 406. During processing of the input view, the machine-learning algorithms may compare isolated (or segmented) objects of the input view (as illustrated by boundary identifier 404 surrounding shoe 402) to pre-identified images of objects that are part of a trained model dataset. According to these comparison results, appropriate action responses may be generated and presented near the segmented object within the viewing window in the live camera mode. As illustrated, shoe 402 is identified by action response label 408 as “Retro OG Men's Shoe.” Selecting action response label 408 may redirect the user to a search engine with “Retro OG Men's Shoe” as the search query. In other example aspects, the action response label 408 may redirect the user to a product page on the shoe 402 manufacturer's website.

Additionally or alternatively, action response label 410 may redirect the user to an online store. The online store may include, but is not limited to, the Amazon® online store or the shoe 402 manufacturer's online store. Action response label 412 may redirect the user to a maps application with directions to the nearest store that currently carries the “Retro OG Men's Shoes” in stock. Other action responses may be provided in further example aspects. For example, some action responses may trigger third-party applications, such as Twitter®, Snapchat® or Facebook®. For example, a user may be provided with an action response that allows the user to post a photo of the Retro OG Men's Shoes to a social media profile. In further example aspects, an action response may open a messaging application (e.g., text messaging application, email application, etc.) and automatically attach an image of the Retro OG Men's Shoes to a draft message.

In other example aspects, multiple objects may be located within the input view and identified. As illustrated, in addition to shoe 402, basketball 414 may be located within the input view and identified. A boundary identifier may surround the basketball 414, just as a boundary identifier surrounded shoe 402. With two objects identified in the input view, the user may toggle back and forth between shoe 402 and basketball 414. As illustrated by action response 408, the user has toggled to shoe 402. However, if the user toggles to basketball 414, action response 408 may change from “Retro OG Men's Shoes” to “Indoor Game Basketball,” for example.

In further example aspects, action responses for multiple objects may displayed on the screen of the electronic device. For example, both action response 408 with “Retro OG Men's Shoes” and another action response “Indoor Game Basketball” may be displayed simultaneously on the screen. As such, the user may be able to select any of the provided action responses on the screen.

As should be appreciated, the various methods, devices, components, etc., described with respect to FIGS. 4A, 4B, and 4C are not intended to limit systems 400 to being performed by the particular components described. Accordingly, additional topology configurations may be used to practice the methods and systems herein and/or components described may be excluded without departing from the methods and systems disclosed herein.

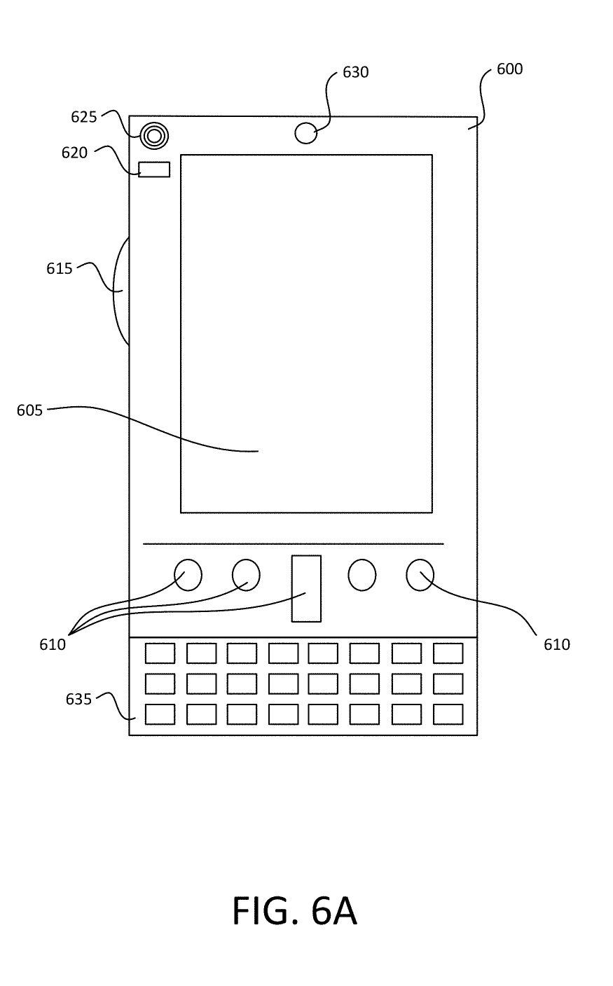

FIGS. 5-8 and the associated descriptions provide a discussion of a variety of operating environments in which aspects of the disclosure may be practiced. However, the devices and systems illustrated and discussed with respect to FIGS. 5-8 are for purposes of example and illustration and are not limiting of a vast number of computing device configurations that may be utilized for practicing aspects of the disclosure, as described herein.

FIG. 5 is a block diagram illustrating example physical components (e.g., hardware) of a computing device 500 with which aspects of the disclosure may be practiced. The computing device components described below may have computer-executable instructions for implementing an object segmentation manager 520 on a computing device (e.g., server computing device and/or client computing device). The computer-executable instructions for an object segmentation manager 520 can be executed to implement the methods disclosed herein, including a method of segmenting at least one object in real-time from an input view and providing at least one action response associated with the at least one segmented object. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories. The system memory 504 may include an operating system 505 and one or more program modules 506 suitable for running an object segmentation manager 520, such as one or more components with regard to FIGS. 1, 2, 3, 4A, 4B, and 4C, and, in particular, an input manager 511, a boundary identifier manager 513, an action response provider 515, and/or UX Component 517.

The operating system 505, for example, may be suitable for controlling the operation of the computing device 500. Furthermore, embodiments of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., object segmentation manager 520) may perform processes including, but not limited to, the aspects, as described herein. Other program modules that may be used in accordance with aspects of the present disclosure, and in particular for segmenting at least one object in real-time from an input view and providing at least one action response associated with the at least one segmented object, may include an input manager 511, a boundary identifier manager 513, an action response provider 515, and/or UX Component 517, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing device 500 may also have one or more input device(s) 512 such as a keyboard, a mouse, a pen, a sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include tangible storage media such as RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such tangible computer storage media may be part of the computing device 500. Computer storage media may be non-transitory media that does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

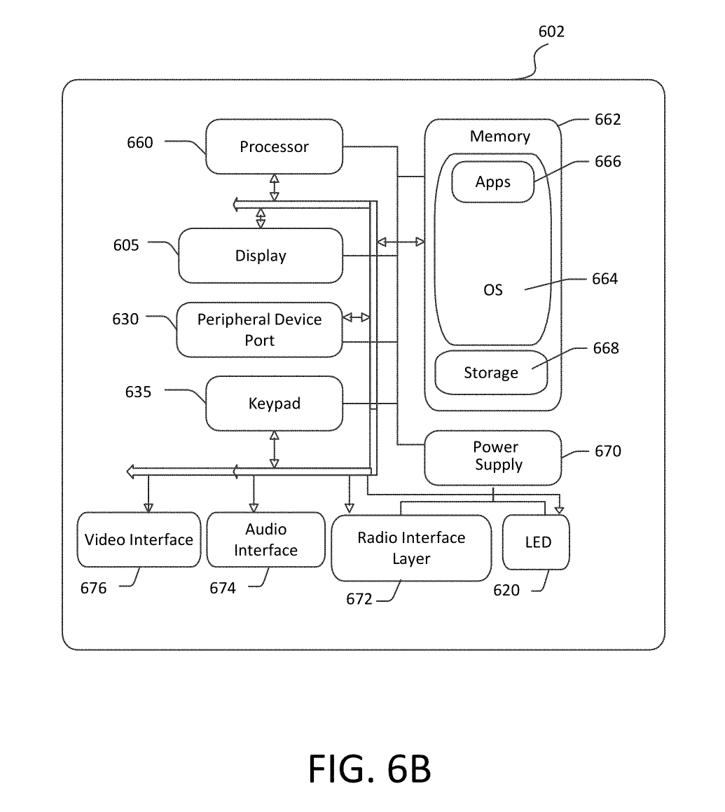

FIGS. 6A and 6B illustrate a mobile computing device 600, for example, a mobile telephone, a smart phone, wearable computer (such as a smart watch or head-mounted display for virtual reality applications), a tablet computer, a laptop computer, and the like, with which embodiments of the disclosure may be practiced. In some aspects, the client may be a mobile computing device. With reference to FIG. 6A, one aspect of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some embodiments. In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display. In various embodiments, the output elements include the display 605 for showing a graphical user interface (GUI), a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one aspect of a mobile computing device. That is, the mobile computing device 600 can incorporate a system (e.g., an architecture) 602 to implement some aspects. In one embodiment, the system 602 is implemented as a “smart phone” capable of running one or more applications (e.g., browser, e-mail, calendaring, contact managers, messaging clients, games, and media clients/players). In some aspects, the system 602 is integrated as a computing device, such as an integrated personal digital assistant (PDA) and wireless phone.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as email or other messages used by an email application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600, including the instructions for segmenting at least one object in real-time from an input view and providing at least one action response associated with the at least one segmented object as described herein (e.g., input manager 511, boundary identifier manager 513, action response provider 515, and/or UX Component 517, etc.).

The system 602 has a power supply 670, which may be implemented as one or more batteries. The power supply 670 may further include an external power source, such as an AC adapter or a powered docking cradle that supplements or recharges the batteries. The system 602 may also include a radio interface layer 672 that performs the function of transmitting and receiving radio frequency communications. The radio interface layer 672 facilitates wireless connectivity between the system 602 and the “outside world,” via a communications carrier or service provider. Transmissions to and from the radio interface layer 672 are conducted under control of the operating system 664. In other words, communications received by the radio interface layer 672 may be disseminated to the application programs 666 via the operating system 664, and vice versa.

The visual indicator 620 may be used to provide visual notifications, and/or an audio interface 674 may be used for producing audible notifications via an audio transducer 625 (e.g., audio transducer 625 illustrated in FIG. 6A). In the illustrated embodiment, the visual indicator 620 is a light emitting diode (LED) and the audio transducer 625 may be a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments of the present disclosure, the microphone may also serve as an audio sensor to facilitate control of notifications, as will be described below. The system 602 may further include a video interface 676 that enables an operation of peripheral device 630 (e.g., on-board camera) to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio interface layer 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio interface layer 672 or via a distributed computing network. Similarly, such data/information may be readily transferred between computing devices for storage and use according to well-known data/information transfer and storage means, including electronic mail and collaborative data/information sharing systems.

As should be appreciated, FIGS. 6A and 6B are described for purposes of illustrating the present methods and systems and are not intended to limit the disclosure to a particular sequence of steps or a particular combination of hardware or software components.

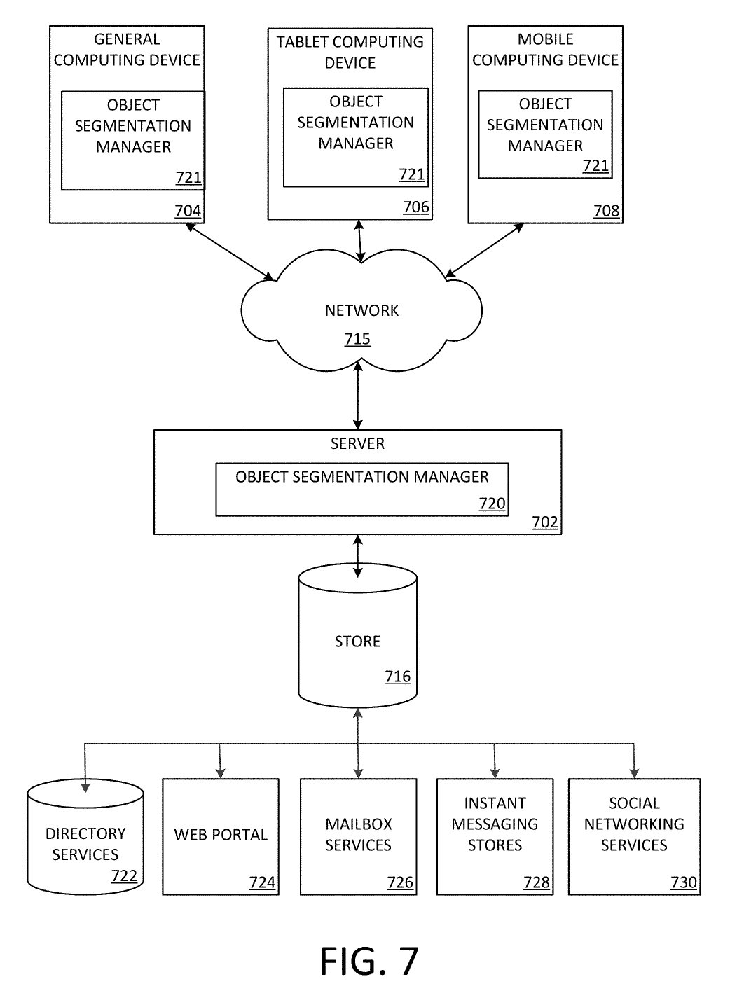

FIG. 7 illustrates one aspect of the architecture of a system for processing data received at a computing system from a remote source, such as a general computing device 704 (e.g., personal computer), tablet computing device 706, or mobile computing device 708, as described above. Content displayed at server device 702 may be stored in different communication channels or other storage types. For example, various documents may be stored using a directory service 722, a web portal 724, a mailbox service 726, an instant messaging store 728, or a social networking service 730. The object segmentation manager 721 may be employed by a client that communicates with server device 702, and/or the object segmentation manager 720 may be employed by server device 702. The server device 702 may provide data to and from a client computing device such as a general computing device 704, a tablet computing device 706 and/or a mobile computing device 708 (e.g., a smart phone) through a network 715. By way of example, the computer system described above with respect to FIGS. 1-6 may be embodied in a general computing device 704 (e.g., personal computer), a tablet computing device 706 and/or a mobile computing device 708 (e.g., a smart phone). Any of these embodiments of the computing devices may obtain content from the store 716, in addition to receiving graphical data useable to either be pre-processed at a graphic-originating system or post-processed at a receiving computing system.

As should be appreciated, FIG. 7 is described for purposes of illustrating the present methods and systems and is not intended to limit the disclosure to a particular sequence of steps or a particular combination of hardware or software components.

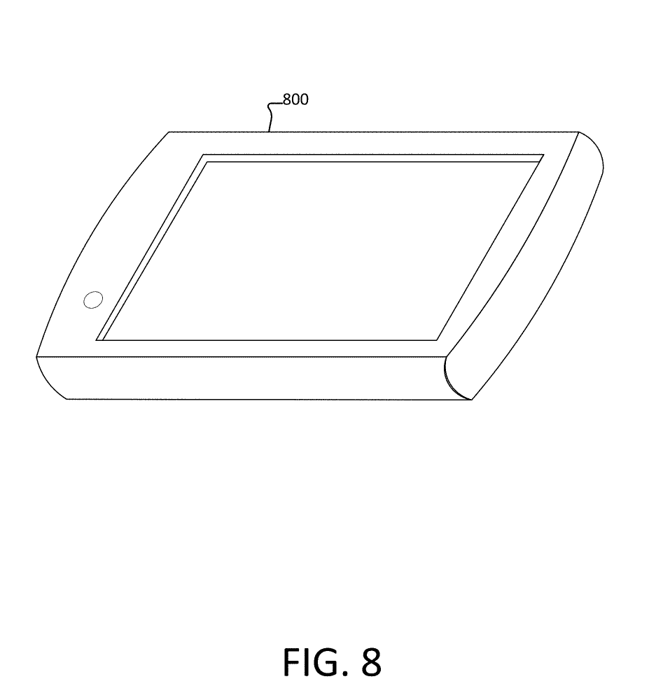

FIG. 8 illustrates an exemplary tablet computing device 800 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As should be appreciated, FIG. 8 is described for purposes of illustrating the present methods and systems and is not intended to limit the disclosure to a particular sequence of steps or a particular combination of hardware or software components.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A processor-implemented method for segmenting objects in a live camera mode of an electronic device, comprising:
receiving at least one input view via a camera application in a viewing window on the electronic device;
processing the at least one input view;
recognizing at least one object within the at least one input view; and
providing at least one selectable action response associated with the at least one object in the viewing window of the electronic device.

2. The processor-implemented method of claim 1, further comprising:
providing at least one boundary identifier around the at least one object.

3. The processor-implemented method of claim 2, wherein the at least one boundary identifier is comprised of smart dots.

4. The processor-implemented method of claim 1, wherein processing the at least one input view further includes applying at least one machine-learning algorithm to the at least one input view.

5. The processor-implemented method of claim 4, wherein the at least one machine-learning algorithm is a convoluted neural network.

6. The processor-implemented method of claim 1, wherein processing the at least one input view further includes comparing the at least one input view with at least one trained model.

7. The processor-implemented method of claim 6, wherein the at least one trained model includes at least one image with at least one pre-identified object.

8. The processor-implemented method of claim 1, further comprising:
storing the at least one input view and the at least one action response in a database.

9. The processor-implemented method of claim 2, wherein the at least one boundary identifier is a solid line.

10. The processor-implemented method of claim 1, wherein the at least one selectable action response redirects to a search engine.

11. The processor-implemented method of claim 1, wherein the at least on selectable action response redirects to an online marketplace.

12. The processor-implemented method of claim 2, further comprising:
determining a movement of the electronic device; and
based on the determination of the movement of the electronic device, recalculating the at least one boundary identifier around the at least one object.

13. A computing device comprising:
at least one processing unit;
at least one memory storing processor-executable instructions that when executed by the at least one processing unit cause the computing device to:
receive at least one input view via a camera application in a viewing window on the computing device;
process the at least one input view;
recognize at least one object within the at least one input view;
apply at least one boundary identifier to the at least one object; and
provide at least one selectable action response associated with the at least one object in the viewing window of the computing device.

14. The computing device of claim 14, wherein the at least one selectable action response comprises a clickable button.

15. The computing device of claim 15, wherein the clickable button redirects to at least one of: a search engine, an online marketplace, a messaging application, and a third-party application.

16. The computing device of claim 16, wherein the third-party application includes at least one of: a social media application and a maps application.

17. The computing device of claim 14, wherein the at least one boundary identifier includes at least one of: smart dots and a solid line.

18. The computing device of claim 14, wherein processing the at least one input view further comprises applying at least one machine-learning algorithm.

19. A processor-readable storage medium storing instructions for executing on one or more processors of a computing device, a method for segmenting objects in the viewing window of the computing device, the method comprising:
receiving at least one input view via a camera application in a viewing window on the electronic device;
processing the at least one input view;
recognizing at least one object within the at least one input view;
applying at least one boundary identifier to the at least one object; and
providing at least one action response associated with the at least one object in the viewing window of the computing device.

20. The processor-readable storage medium of claim 19, wherein processing the at least one input view further includes applying at least one machine-learning algorithm to the at least one input view.
